(19) United States
(12) Patent Application Publication
(10) Pub. No.: US 2012/0293430 A1
(43) Pub. Date: Nov. 22, 2012

(54) TOUCH SCREEN DEVICE AND PLASMA DISPLAY APPARATUS HAVING THE SAME

(75) Inventor: Takashi KITADA, Fukuoka (JP)

(73) Assignee: PANASONIC CORPORATION, Osaka (JP)

(21) Appl. No.: 13/471,585

(22) Filed: May 15, 2012

(30) Foreign Application Priority Data
May 19, 2011 (JP) 2011-112051

(51) Int. Cl. G06F 3/041; G09G 3/28

(52) U.S. Cl. 345/173

(57) ABSTRACT

A touch screen device has a screen main body including parallel transmitting electrodes and parallel receiving electrodes disposed in a grid shape; a transmitter sequentially selecting the transmitting electrodes and applying a drive signal; a receiver sequentially selecting the receiving electrodes, receiving a response signal output from the receiving electrode in response to the drive signal, and outputting detection data at each electrode intersection; a controller obtaining a touch position based on the detection data at each electrode intersection output from the receiver; and a reference signal generator outputting a reference signal for synchronized detection. The transmitter generates the drive signal from the reference signal. The receiver uses the reference signal to perform synchronized detection of a signal based on the response signal from the receiving electrode and generates the detection data.

### CROSS-REFERENCE TO RELATED APPLICATIONS

The present application claims priority under 35 U.S.C. §119 of Japanese Application No. 2011-112051 filed on May 19, 2011, the disclosure of which is expressly incorporated by reference herein in its entirety.

### BACKGROUND OF THE INVENTION

1. Field of the Invention

The present invention relates to a touch screen device that detects a touch position by a capacitance method and a plasma display apparatus having the touch screen device.

2. Description of Related Art

There are various methods, based upon different principles, for a touch screen device to detect a touch position. In a configuration where numerous electrodes are provided in a panel, such as in resistive and capacitance types, the electrodes act as antennas, and are thus susceptible to exogenous noise. In the capacitance type, in particular, a touch position is detected from a minor variation in capacitance proximate to electrodes caused by the approach or contact of a conductive object (e.g., human body). Thus, noise substantially affects accuracy in detecting a touch position.

A touch screen device is generally used in combination with an image display apparatus, such as a liquid crystal display panel. Integrating an image display apparatus with a touch screen device reduces accuracy in detecting a touch position due to noise caused by the image display apparatus. A technology is known to reduce an impact of such noise attributed to the image display apparatus (Related Arts 1 and 2).

A plasma display panel is considered as such an image display apparatus used in combination with the touch screen device. Due to substantial radiated noise associated with discharge of a plasma display panel, however, the conventional noise reduction measure does not sufficiently solve the noise issue and substantially reduces the accuracy in detecting a touch position, and is thus incapable of ensuring sufficient detection accuracy in practice.
[Related Art 1] Japanese Patent Laid-open Publication No. S63-174120
[Related Art 2] Japanese Patent Laid-open Publication No. 2010-009439

### SUMMARY OF THE INVENTION

In view of the circumstances above, an objective of the present invention is to provide a touch screen device and a plasma display apparatus having the same, the touch screen device being configured to prevent a reduction in detection accuracy of a touch position due to exogenous noise attributable to a plasma display panel.

A touch screen device of the present invention includes a screen main body comprising a plurality of transmitting electrodes provided parallel to one another and a plurality of receiving electrodes provided parallel to one another, the transmitting electrodes and the receiving electrodes being disposed in a grid shape; a reference signal generator outputting a reference signal; a transmitter generating a drive signal from the reference signal, sequentially selecting the transmitting electrodes and applying the drive signal; and a receiver sequentially selecting the receiving electrodes and receiving a response signal output from each of the receiving electrodes in response to the drive signal. The receiver comprises a synchronized detector performing synchronized detection for a signal based on the response signal from the receiving electrode, by using the reference signal, and generating detection data, at each electrode intersection, from a signal output from the synchronized detector A controller obtains a touch position based on the detection data at each electrode intersection output from the synchronized detector of the receiver.

According to the present invention, the drive signal is generated from the reference signal and has the same frequency and phase as the reference signal. Thus, the response signal is output from the receiving electrode with the same frequency and phase as the reference signal. Furthermore, the reference signal is used to preform synchronized detection of a signal based on the response signal from the receiving electrode. Thereby, noise having a different frequency from the reference signal is removed and only a signal value for the response signal from the receiving electrode having the same frequency as the reference signal is obtained. This prevents a reduction in detection accuracy of a touch position due to exogenous noise.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an overall configuration of a plasma display apparatus according to an embodiment;

FIG. 2 is a plan view illustrating transmitting electrodes and receiving electrodes;

FIGS. 3A to 3C each schematically illustrate discharge control of a plasma display panel (PDP);

FIG. 4 schematically illustrates discharge control of the PDP;

FIGS. 5A and 5B are each waveform diagram illustrating radiated noise of the PDP;

FIG. 6 schematically illustrates a configuration of an antenna receiving circuit;

FIG. 7 is a flowchart illustrating a procedure for processing performed in a controller;

FIG. 8 is a chart illustrating frequency characteristics of radiated noise during an address discharge period of the PDP;

FIG. 9 schematically illustrates a configuration of a reception signal processor of a receiver;

FIG. 10 is a timing chart illustrating a state of a reference signal, a drive signal, a response signal, and output signals from the reception signal processor of the receiver;

FIGS. 11A to 11C illustrate frequency characteristics of an output signal from a multiplier, a reception signal, and a reference signal, respectively;

FIGS. 12A to 12C illustrate waveforms of output signals from a low pass filter (LPF) and the multiplier of a synchronized detector; and

FIG. 13 illustrates a waveform of an output signal from the LPF.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

An embodiment of the present invention is explained below with reference to the drawings.

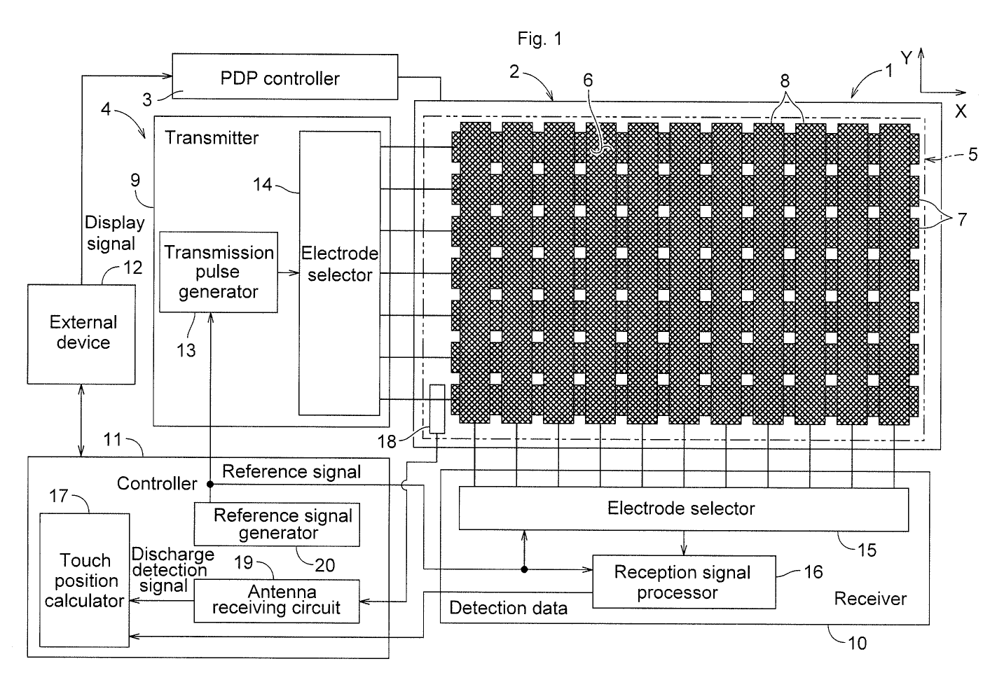

FIG. 1 illustrates an overall configuration of a plasma display apparatus 1 according to the present embodiment. The plasma display apparatus 1 has a plasma display panel (hereinafter referred to as PDP) 2, a PDP controller 3, and a touch screen device 4. A screen main body 5 of the touch screen device 4 is disposed in front of a display surface of the PDP 2.

The screen main body 5 of the touch screen device 4 has a touch surface 6 on which a touch operation is performed with a pointing object (conductive body, such as a user's fingertip, a stylus, or a pointer). A plurality of transmitting electrodes 7 in parallel with one another and a plurality of receiving electrodes 8 in parallel with one another are disposed in a grid shape.

The touch screen device 4 also includes a transmitter 9, a receiver 10, and a controller 11, the transmitter 9 applying a drive signal to the transmitting electrode 7, the receiver 10 receiving a response signal from the receiving electrode 8 that has responded to the drive signal applied to the transmitting electrode 7 and outputting detection data at each electrode intersection where the transmitting electrode 7 and the receiving electrode 8 intersect, the controller 11 detecting a touch position based on the detection data output from the receiver 10 and controlling operations of the transmitter 9 and the receiver 10.

The touch position information output from the controller 11 is input to an external device 12, such as a personal computer, which generates and outputs display screen data to the PDP controller 3 that controls the PDP 2. Thus, the PDP 2 displays on the screen an image corresponding to a touch operation performed by a user with a pointing object on the touch surface 6 of the screen main body 5, allowing display of a predetermined image in a manner similar to directly drawing on the touch surface 6 with a marker and allowing operation of buttons displayed on the display screen of the PDP 2. An eraser is also available to delete an image drawn with a touch operation.

The transmitting electrodes 7 and the receiving electrodes 8 intersect in a stacked state with an insulating layer therebetween. A capacitor is formed in an electrode intersection where the transmitting electrode 7 and the receiving electrode 8 intersect. A pointing object, such as a finger, approaches or comes into contact with the touch surface 6 as a user performs a touch operation with the pointing object. Then, the capacitance at the electrode intersection is substantially reduced, thus allowing detection of the touch operation.

A mutual capacitance system is employed herein. A drive signal is applied to the transmitting electrode 7, and then a charge-discharge current flows to the receiving electrode 8 in response. The charge-discharge current is output from the receiving electrode 8 as a response signal. A variation in the capacitance at the electrode intersection at this time in response to a user's touch operation varies the charge-discharge current of the receiving electrode 8, and specifically, the response signal. The touch position is calculated based on the variation amount. In this mutual capacitance system, detection data obtained from signal processing of the response signal in the receiver 10 is output for each electrode intersection of the transmitting electrode 7 and the receiving electrode 8, thus enabling what is commonly called multi-touch (multiple point detection), which simultaneously detects a plurality of touch positions.

A touch position calculator 17 of the controller 11 obtains a touch position (center coordinate of a touch area) based on predetermined calculation of detection data at each electrode intersection output from the receiver 10. In this touch position calculation, a touch position is calculated in a predetermined interpolating method (e.g., centroid method) from detection data of each of a plurality of adjacent electrode intersections (e.g., 4×4) in the X direction (array direction of the receiving electrodes 8, specifically, the width direction of the PDP 2) and the Y direction (array direction of the transmitting electrodes 7, specifically, the height direction of the PDP 2). Thereby, the touch position can be detected at a higher resolution (e.g., 1 mm or less) than the placement pitch (e.g., 10 mm) of the transmitting electrodes 7 and the receiving electrodes 8.

The touch position calculator 17 of the controller 11 also obtains a touch position every frame period in which receipt of detection data at each electrode intersection is completed across the entire touch surface 6. The touch position calculator 17 then outputs the touch position information to the external device 12 in a unit of frames. Based on the touch position information of a plurality of temporally continuing frames, the external device 12 generates and outputs to the PDP controller 3 display screen data of touch positions connected in time series. In a case of multi-touch, the touch position information including touch positions by a plurality of pointing objects is output in a unit of frames.

The transmitter 9 has a transmission pulse generator 13 generating pulses to serve as drive signals and an electrode selector 14 selecting the transmitting electrodes 7 one by one and sequentially applying the pulses output from the transmission pulse generator 13 to the transmitting electrodes 7.

The receiver 10 has a reception signal processor 16 processing response signals output from the receiving electrodes 8 and an electrode selector 15 selecting the receiving electrodes 8 one by one and sequentially supplying the response signals from the receiving electrodes 8 to the reception signal processor 16.

During a time when the transmitter 9 applies a drive signal to one transmitting electrode 7, the receiver 10 selects the receiving electrodes 8 one by one and sequentially supplies response signals from the receiving electrodes 8 to the reception signal processor 16 for signal processing. Sequentially repeating this scanning of one line for all transmitting electrodes 7 provides detection data at every electrode intersection.

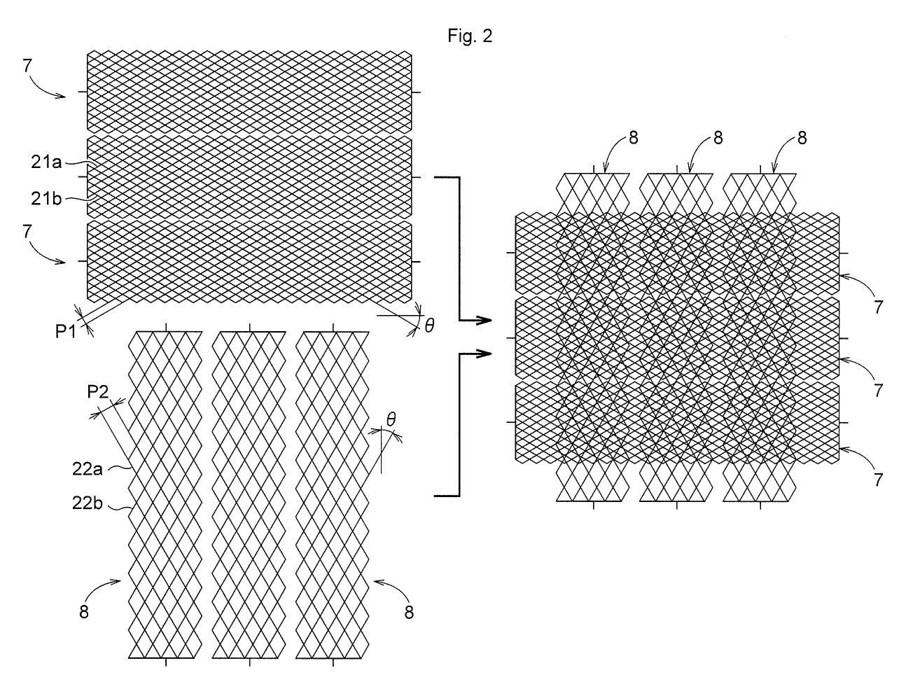

FIG. 2 is a plan view illustrating the transmitting electrodes 7 and the receiving electrodes 8. The transmitting electrodes 7 include mesh electrodes having conductive wires 21a and 21b disposed in a grid pattern. The conductive wires 21a extend obliquely at a predetermined angle θ clockwise relative to the longitudinal direction of the transmitting electrodes 7, while the conductive wires 21b extend obliquely at the predetermined angle θ counterclockwise relative to the longitudinal direction of the transmitting electrodes 7. An intersecting angle 2θ of the conductive wires 21a and 21b is set to less than 90° to provide a continuous rhombic grid pattern. The conductive wires 21a and 21b are electrically connected at intersected portions.

Similar to the transmitting electrodes 7, the receiving electrodes 8 include mesh electrodes having conductive wires 22a and 22b disposed in a grid pattern. The arrangement pattern of the conductive wires 22a and 22b is similar to that of the conductive wires 21a and 21b; however, a mesh pitch P2 of the receiving electrodes 8 is greater than a mesh pitch P1 of the transmitting electrodes 7 (P1<P2).

In such a configuration of the transmitting electrodes 7 and the receiving electrodes 8, the conductive wires 21a, 21b, 22a, and 22b are each formed into a fine line diameter, thus decreasing visibility of the transmitting electrodes 7 and the receiving electrodes 8 so as to enhance visibility of the screen of the PDP 2 disposed in the rear of the touch screen device 4. In addition, moiré, which is generated due to overlapping of the transmitting electrodes 7 and the receiving electrodes 8 on a pixel pattern of the PDP 2, is prevented. With the increased mesh pitch of the receiving electrodes 8, a variation rate of the response signal associated with a touch operation increases, thus enhancing detection accuracy of a touch position.

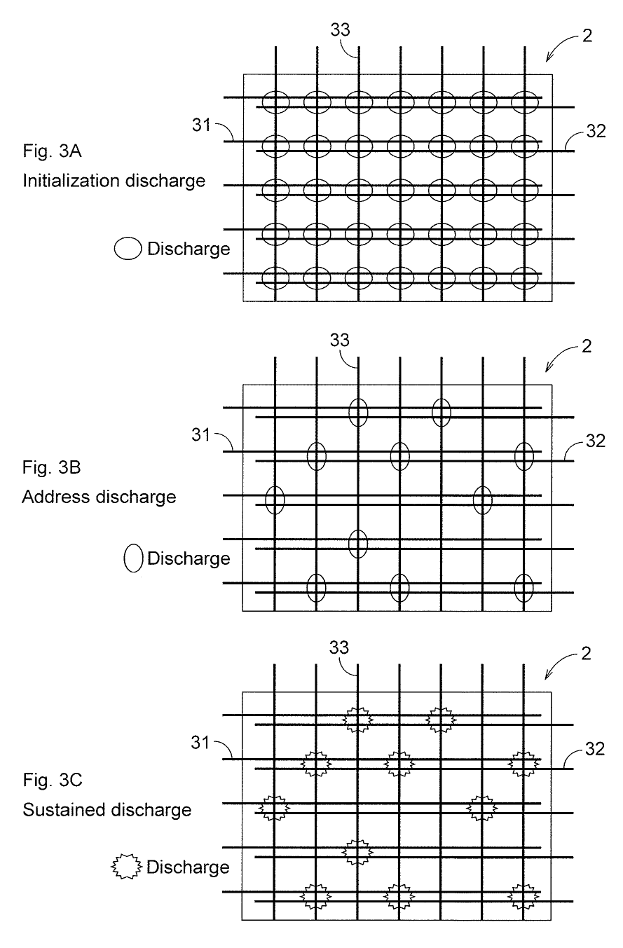

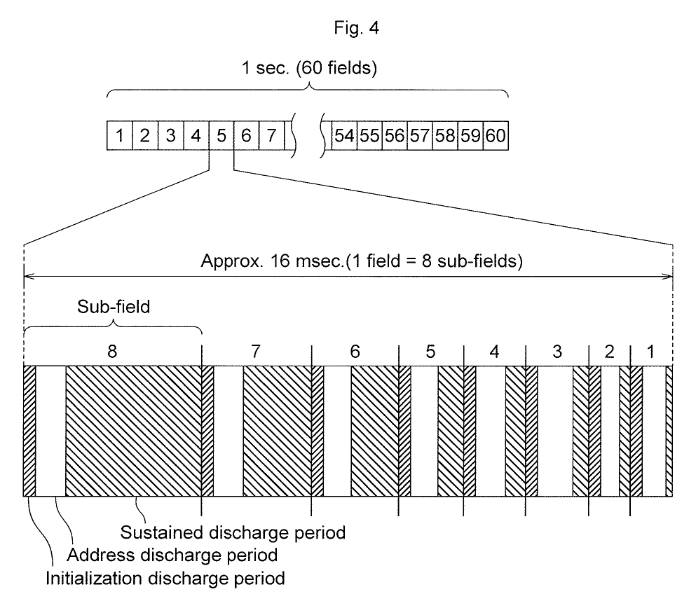

FIGS. 3A to 3C and 4 schematically illustrate discharge control of the PDP 2. With reference to FIGS. 3A to 3C, the PDP 2 has sustaining electrodes 31, scanning electrodes 32, and address electrodes 33. The sustaining electrodes 31 and the scanning electrodes 32 are disposed in parallel to each other. The address electrodes 33 are disposed orthogonal to the sustaining electrodes 31 and the scanning electrodes 32. The PDP 2 is driven in an ADS (Address and Display period Separated) sub-field method. As shown in FIG. 4, one field is divided into a plurality (eight herein) of sub-fields on the time axis. Initialization discharge, address discharge, and sustained discharge are sequentially repeated in each sub-field to display multi-tone images.

As illustrated in FIG. 3A, in the initialization discharge, discharge occurs between the sustaining electrodes 31 and the scanning electrodes 32 and simultaneously at all discharge cells. As illustrated in FIG. 3B, in the address discharge, discharge occurs between the scanning electrodes 32 and the address electrodes 33, and the discharge cells are selected that are positioned in intersections of the scanning electrodes 32 and the address electrodes 33. As illustrated in FIG. 3C, in the sustained discharge, discharge occurs between the sustaining electrodes 31 and the scanning electrodes 32, and only the discharge cells selected in the address discharge are discharged, thus enabling display of an image.

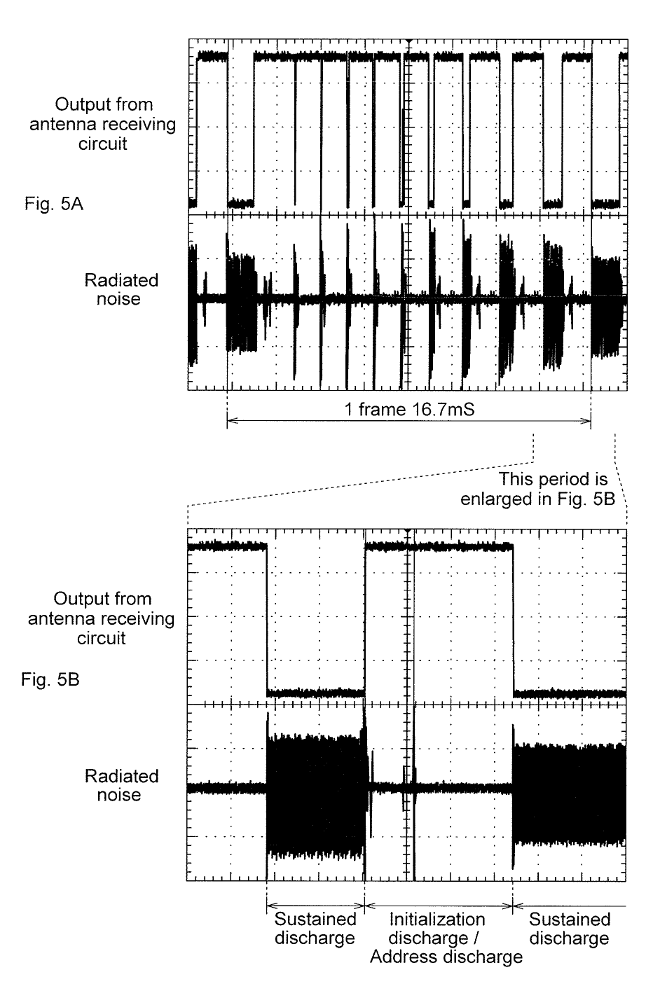

FIGS. 5A and 5B are each a waveform diagram illustrating radiated noise in the PDP 2. FIG. 5B illustrates an enlargement of a main portion in FIG. 5A. Radiated noise is generated in any of the initialization discharge, address discharge, and sustained discharge periods. However, the radiated noise is particularly large in the sustained discharge period, compared with the initialization discharge and address discharge periods. Due to the radiated noise, a touch position is wrongly detected. Thus, in the present embodiment, as described below, the sustained discharge period, when the radiated noise is particularly large, is detected to enhance noise resistance.

As shown in FIG. 1, the touch screen device 4 has an antenna 18 detecting the radiated noise from the PDP 2. The controller 11 has an antenna receiving circuit (sustained discharge detector) 19 detecting the sustained discharge period of the PDP 2 based on an output signal from the antenna 18. The touch position calculator 17 calculates a touch position based only on detection data at each electrode intersection obtained during periods other than the sustained discharge period according to detection results of the antenna receiving circuit 19.

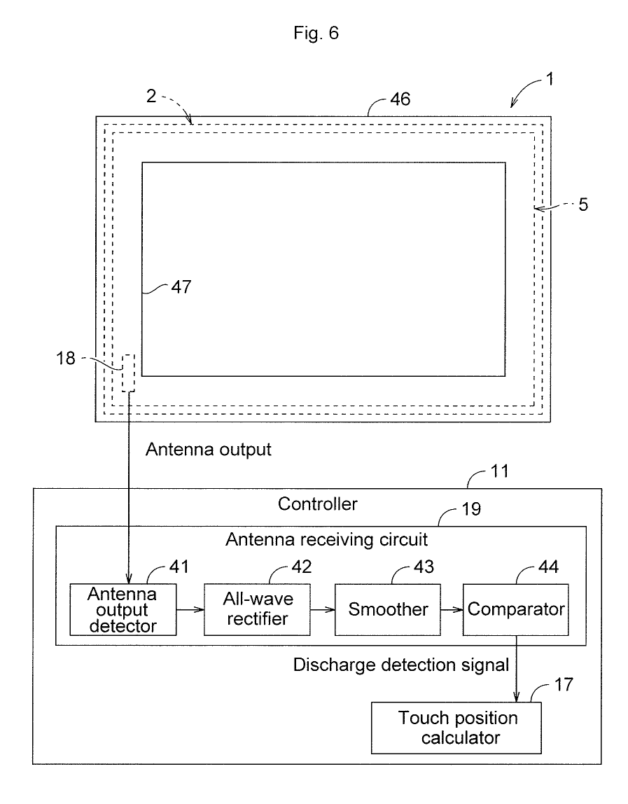

FIG. 6 schematically illustrates a configuration of the antenna receiving circuit 19. The antenna receiving circuit 19 processes an analog signal output from the antenna 18 and outputs a discharge detection signal indicating a sustained discharge period. The antenna receiving circuit 19 has an antenna output detector 41, an all-wave rectifier 42, a smoother 43, and a comparator 44.

In the antenna receiving circuit 19, the output signals from the antenna 18 are input to the antenna output detector 41 and undergo all-wave rectification in the all-wave rectifier 42 and smoothing in the smoother 43. Based on comparison with a predetermined threshold, the comparator 44 outputs discharge detection signals indicating a sustained discharge period. Radiated noise is pronounced during the sustained discharge period in the PDP 2. Thus, the sustained discharge period can be detected from the level of the radiated noise (refer to FIGS. 5A and 5B). The discharge detection signals may have any format to which the touch position calculator 17 can refer for the sustained discharge period during scanning.

The antenna 18 may be composed of a looped conductive wire mounted on a board. In order to enhance sensitivity, it is preferred that the antenna 18 have a resonant frequency proximate to the operating frequency of the PDP 2. The antenna 18 may be disposed in a position other than the display area of the PDP 2, specifically in a position covered by a bezel 47 of a case 46 that houses the screen main body 5 and the PDP 2.

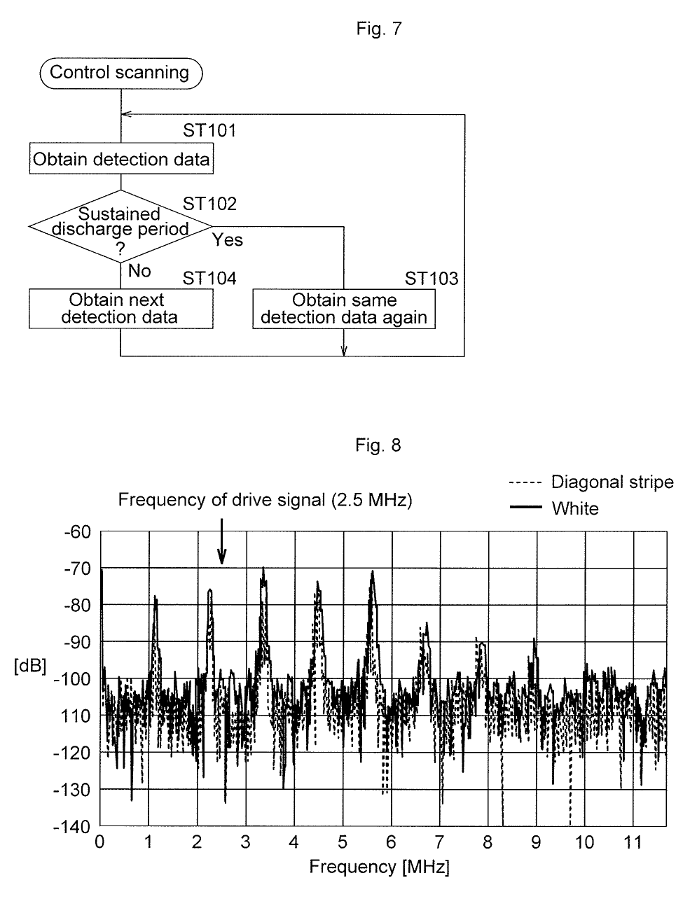

FIG. 7 is a flowchart illustrating a procedure for processing performed in the controller 11. Regardless of the sustained discharge period in the PDP 2, scanning is performed, specifically, the transmitter 9 applies drive signals to the transmitting electrodes 7 and the receiver 10 processes output signals from the receiving electrodes 8. Then, detection data obtained during the sustained discharge period is discarded, and scanning is performed again to obtain data for the discarded detection data at an electrode intersection again.

Specifically, scanning is first performed to obtain detection data at each electrode intersection (ST101). Then, when discharge detection signals output from the antenna receiving circuit 19 indicate the sustained discharge period (ST102: Yes), detection data at the same electrode intersection is obtained again (ST103). If it is not the sustained discharge period (ST102: No), detection data at the next electrode intersection is obtained (ST104).

By discarding the detection data obtained during the sustained discharge period and performing scanning again as above, the detection data at each electrode intersection during a period other than the sustained discharge period, specifically during only the initialization discharge period or address discharge period, can be obtained for one frame. After the detection data for one frame is obtained, a touch position is calculated based on the detection data.

The controller 11 obtains the detection data of each electrode intersection from the receiver 10 through scanning and concurrently receives a discharge detection signal of the antenna receiving circuit 19. Then, it is determined whether or not the detection data is obtained during the sustained discharge period (ST102). It is preferred to discard detection data and perform scanning for obtaining the detection data again in a unit of one line corresponding to one transmitting electrode 7.

FIG. 8 is a chart illustrating frequency characteristics of radiated noise during the address discharge period of the PDP 2. The chart illustrates frequency characteristics when diagonal stripes and white are displayed on the entire screen of the PDP 2.

As described above, a touch position is obtained based on the detection data at each electrode intersection obtained during a period other than the sustained discharge period, specifically during the initialization discharge or address discharge period, in the present embodiment. Thus, the radiated noise has no impact during the sustained discharge period and the initialization discharge lasts a very short time. Accordingly, a main issue is the radiated noise during the address discharge period. During the address discharge period, noise is generated in a variety of frequencies as shown in FIG. 8. In the present embodiment, a frequency of 2.5 MHz having relatively low noise is a frequency of the drive signal.

To remove noise of frequency components other than the frequency of the drive signal, a BPF (bandpass filter) is generally used. There is a case, however, in which relatively large noise is generated at a frequency of 2.7 MHz proximate to the frequency of the drive signal. To remove such noise of frequency components proximate to the frequency of the drive signal, a BPF should have a high (peaked) Q factor. A BPF having a high Q factor, however, has problems, such as a shifted center frequency and a large group delay. Thus, it is difficult to appropriately remove the noise of frequency components proximate to the frequency of the drive signal. Thus, it is desired to enhance noise resistance without using a BPF having a high Q factor.

In the present embodiment, as described below, the receiver 10 performs synchronized detection and the transmitter 9 generates a drive signal from a reference signal for synchronized detection, thus enhancing the noise resistance.

As shown in FIG. 1, the controller 11 has a reference signal generator 20 generating a reference signal for synchronized detection. The reference signal generator 20 generates a reference signal composed of a continuous pulse wave. The reference signal output from the reference signal generator 20 is input to the transmission pulse generator 13 of the transmitter 9 and to the reception signal processor 16 and the electrode selector 15 of the receiver 10. The reference signal generator 20 is not necessarily provided in the controller 11, and may be provided in the transmitter 9 or the receiver 10.

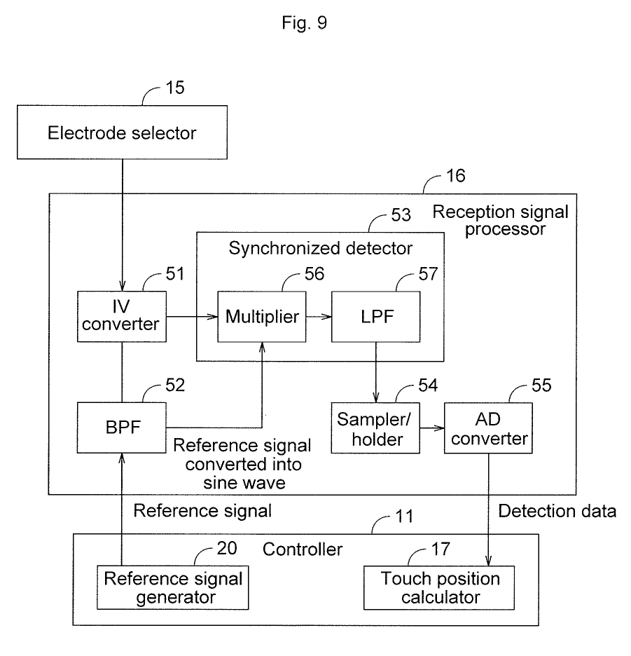

FIG. 9 schematically illustrates a configuration of the reception signal processor 16 of the receiver 10. The reception signal processor 16 has an IV converter 51, a BPF (bandpass filter) (sine wave converter) 52, a synchronized detector 53, a sampler/holder 54, and an AD converter 55. The synchronized detector 53 has a multiplier 56 and a LPF (low pass filter) 57.

The IV converter 51 converts, into a voltage signal, a response signal (charge-discharge current signal) from the receiving electrode 8 and input through the electrode selector 15. The BPF 52 converts, into a sine wave, a reference signal composed of a continuous pulse wave output from the reference signal generator 20. The BPF 52 uses the frequency of the reference signal as a center frequency. The synchronized detector 53 performs synchronized detection of an output signal from the IV converter 51 by using the reference signal converted into a sine wave in the BPF 52. The sampler/holder 54 samples the output signal from the synchronized detector 53 at a predetermined timing. The AD converter 55 converts the output signal from the sampler/holder 54 from analog to digital and outputs detection data (level signal) at every electrode intersection.

The multiplier 56 of the synchronized detector 53 multiplies the output signal from the IV converter 51 and the reference signal converted into a sine wave in the BPF 52. An output signal of the multiplier 56 is expressed as follows, where the output signal from the IV converter 51 is SIN (ωt+α) and the output signal from the BPF 52 is SIN (ωt+β):

$$Multiplier output = A \times SIN ( ω t + α ) \times SIN ( ω t + β ) = A / 2 \times \{ COS ( β - α ) - COS ( 2 ω T + α + β ) \}$$

In the expression above, COS (β−α) represents a DC component and COS (2ωT+α+β) represents an AC component of a doubled frequency.

The LPF 57 removes the AC component of the doubled frequency from the output signal of the multiplier 56 and outputs a signal composed only of the DC component. In a case where noise of a frequency ω1 is mixed in, the frequency ω1 being proximate to the frequency w of the output signal from the IV converter 51 and the output signal from the BPF 52, the frequency of the noise is shifted to (ω1−ω) through multiplication in the multiplier 56, and thus the noise can be removed by the LPF 57.

The reference signal output from the reference signal generator 20 is a pulse wave and thus includes +α frequency components. Specifically, the reference signal is SIN (ωt+β)+SIN (ω2t+β)+ . . . . When the reference signal is input to the multiplier 56 in a form of a pulse wave, the DC component varies in cases where noise is included and is not included, thus being susceptible to noise. To prevent this, the BPF 52 converts the reference signal into a sine wave in the present embodiment. Thus, the reference signal has a single frequency component and the noise resistance is enhanced.

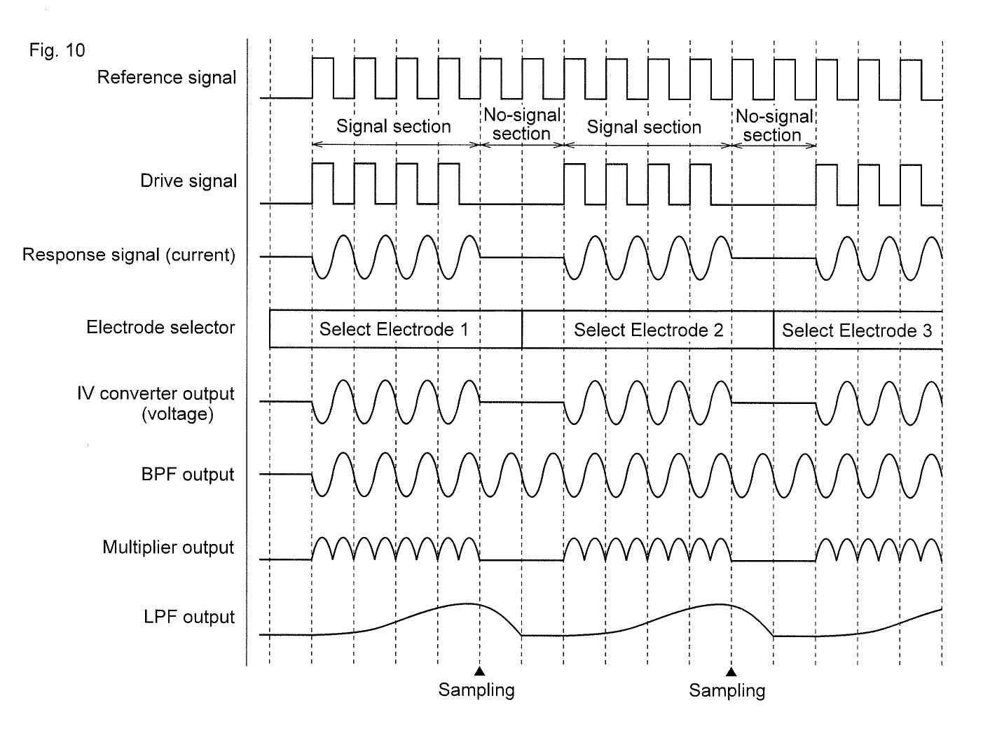

FIG. 10 is a timing chart illustrating a state of a reference signal output from the reference signal generator 20, a drive signal applied to the transmitting electrode 7, a response signal from the receiving electrode 8, and output signals from the reception signal processor 16 of the receiver 10 and an operation state of the electrode selector 15.

The reference signal generator 20 outputs a reference signal which is a continuous pulse wave. The reference signal is input to the transmission pulse generator 13 of the transmitter 9. The transmission pulse generator 13 generates a drive signal from the reference signal. The drive signal is applied to the transmitting electrode 7.

The transmission pulse generator 13, which is composed of a gate circuit, generates the drive signal that is an intermittent pulse wave (burst wave) from the reference signal that is a continuous pulse wave. In the embodiment, the reference signal is selectively picked out to generate the drive signal. In other words, the pulse is selectively removed from the reference signal to generate the drive signal. The pulses of the reference signal and the drive signal have the same frequency and phase.

In response to the drive signal applied to the transmitting electrode 7, the receiving electrode 8 generates the response signal (charge-discharge current signal) having the same frequency as the drive signal. The electrode selector 15 of the receiver 10 selects the receiving electrode 8 in synchronization with the reference signal. The response signal of the receiving electrode 8 selected by the electrode selector 15 is input to the reception signal processor 16.

At this time, the receiving electrode 8 is switched in a no-signal section where a pulse is removed from the drive signal. The response signal of the receiving electrode 8 selected in each signal section where the pulse remains is input to the reception signal processor 16. Thus, the drive signal is used as a burst wave synchronized with selection timing of the receiving electrode 8, and thereby a constant number of pulses can be applied to the transmitting electrode 7 in each period when the response signal is received from one receiving electrode 8.

The IV converter 51 of the reception signal processor 16 converts the response signal from the receiving electrode 8 into a voltage signal. An output signal from the IV converter 51 is generally a sine wave. The BPF 52 converts the reference signal output from the reference signal generator 20 into a sine wave and outputs a reference signal composed of a continuous sine wave. The multiplier 56 multiplies the output signal from the IV converter 51 and the output signal from the BPF 52. Since the frequencies and phases of the two signals are identical, a waveform signal similar to all-wave rectification is output. The LPF 57 passes only a low frequency component in the output signal from the multiplier 56. A signal value gradually increases due to multiplication effects and then decreases. An output signal from the LPF 57 is sampled in the sampler/holder 54 at a predetermined timing.

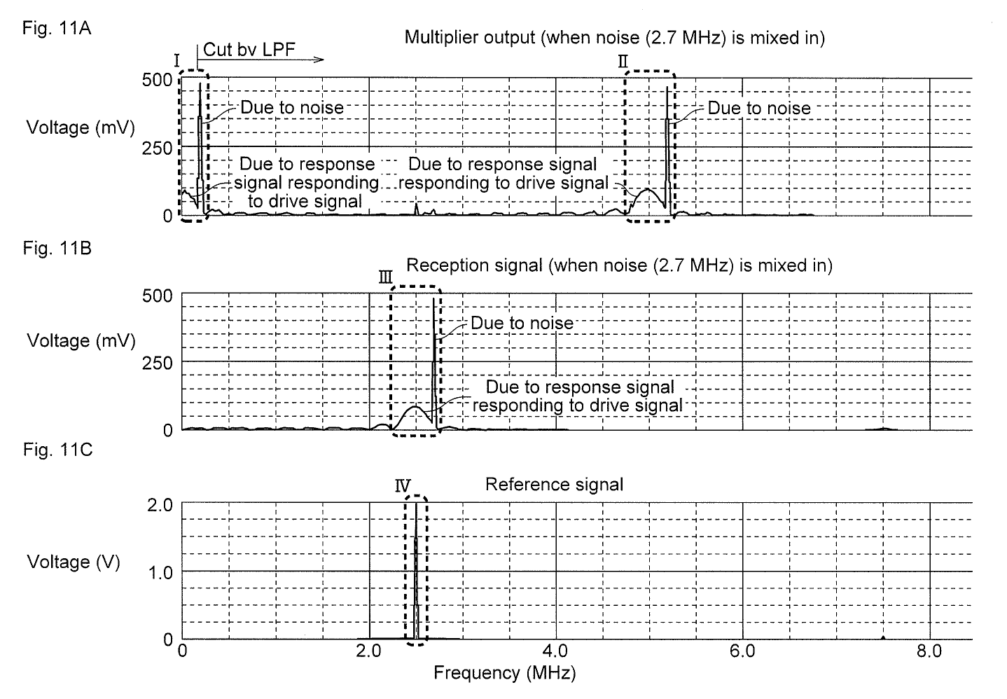

FIGS. 11A to 11C illustrate frequency characteristics of a reception signal, a reference signal, and an output signal from the multiplier 56 that multiplies the reception signal and the reference signal. FIG. 11A illustrates the frequency characteristics of the output signal from the multiplier 56. FIG. 11B illustrates the frequency characteristics of the reception signal (output signal from the IV converter 51) in a case where noise (2.7 MHz) is mixed in. FIG. 11C illustrates the frequency characteristics of the reference signal (output signal from the BPF 52).

With reference to FIG. 11C, the reference signal (output signal from the BPF 52) indicates a peak in a section of the operating frequency (2.5 MHz) (section IV in the drawing). The reference signal, which is a continuous sine wave having a single frequency component, generates no side lobe.

With reference to FIG. 11B, in the reception signal (output signal from the IV converter 51), the response signal responding to the drive signal has the same frequency (2.5 MHz) as the reference signal, which is a base of the drive signal. Thus, a peak associated with the response signal responding to the drive signal is observed in a section of the frequency (section III in the drawing). In particular, the drive signal is a burst wave, and thus a side lobe is generated in the peak associated with the response signal responding to the drive signal. Furthermore, in a case where noise is mixed into the reception signal, a peak appears due to the noise. Since the noise is a continuous wave having a constant frequency, no side lobe is generated in the peak associated with the noise.

The reception signal (output signal from the IV converter 51) illustrated in FIG. 11B is multiplied by the reference signal (output signal from the BPF 52) illustrated in FIG. 11C in the multiplier 56. Then, as illustrated in FIG. 11A, the signal is converted into a DC component in a section where the frequency is proximate to 0 (section I in the drawing) and into an AC component in a section where the frequency is double (section II in the drawing). A peak is observed in each section due to the response signal responding to the drive signal. In a case where noise is mixed into the reception signal, a peak appears in each of the sections II and III due to the noise.

The peak due to the noise in the DC component section (section I in the drawing) is the frequency of difference (0.2 MHz) between the frequency of the drive signal (2.5 MHz) and the frequency of the noise (2.7 MHz). A section having a higher frequency than this frequency is cut by the LPF 57 to take out only a signal from the response signal responding to the drive signal. The noise component is removed by the LPF 57 as above, allowing stable removal of the noise component without a problem of a shifted center frequency, as with the BPF.

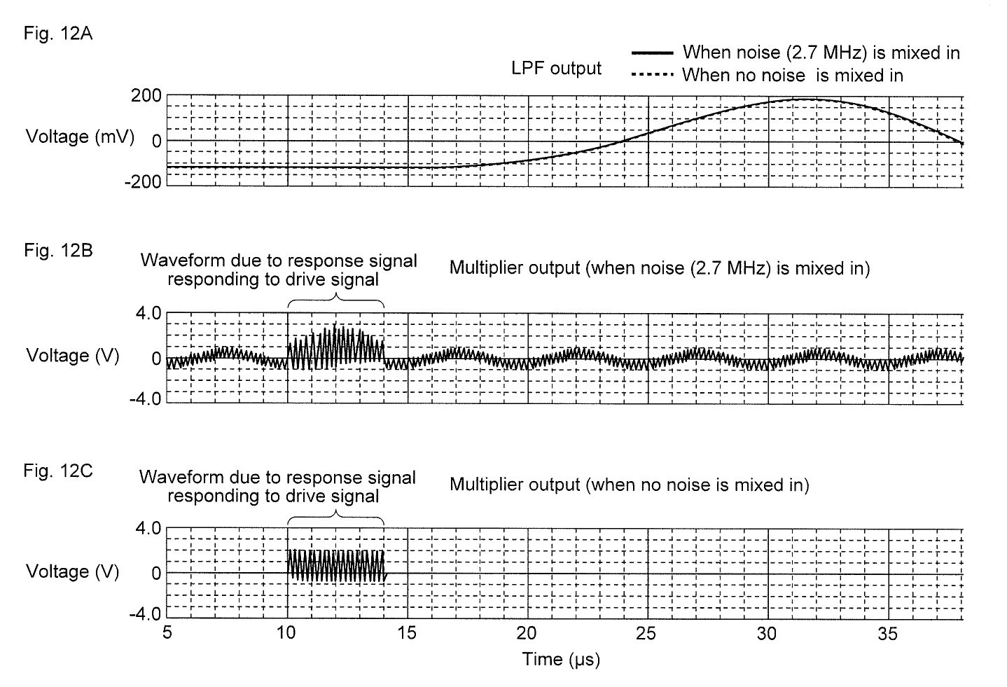

FIGS. 12A to 12C illustrate waveforms of output signals from the multiplier 56 and the LPF 57 of the synchronized detector 53. FIG. 12A illustrates the output signal from the LPF 57. FIG. 12B illustrates the output signal from the multiplier 56 in a case where noise (2.7 MHz) is mixed in. FIG. 12C illustrates the output signal from the multiplier 56 in a case where no noise is mixed in.

With reference to FIGS. 12B and 12C, the output signals from the multiplier 56 each indicate a waveform due to the response signal responding to a drive signal. As shown in FIG. 12B, in particular, a waveform of overlapping a high frequency due to noise and a low frequency is observed in the case where the noise is mixed in. As shown in FIG. 12A, there is no difference in the output signal from the LPF 57 between the cases where noise is mixed in or not, indicating that the output signal is not affected by noise.

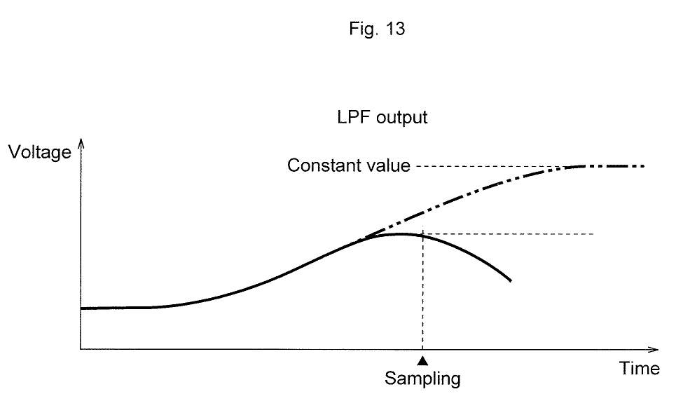

FIG. 13 illustrates a waveform of the output signal from the LPF 57. The LPF 57 outputs a signal having only a DC component of an output signal from the multiplier 56. A signal value output from the LPF 57 converges at a certain value, as indicated with a dashed two-dotted line. It takes time, however, to converge the signal value output from the LPF 57. Thus, sampling at the timing of convergence of the signal value delays the timing to obtain the signal value.

In the present embodiment, the drive signal is used as a burst wave having an appropriate length, and the length of the response signal (refer to FIGS. 12A to 12C) output from the receiving electrode 8 in response to the drive signal is relatively short. Thus, the signal output from the LPF 57 has a waveform declining after reaching a peak value, as indicated with a solid line. The sampler/holder (peak value obtainer) 54 samples the output signal from the LPF 57 proximate to the timing when the signal reaches the peak value. This advances the timing to obtain the signal value, thus reducing the time to output detection data at each electrode intersection and accelerating touch position detection.

Instead of the sampler/holder 54, a peak holder may be provided to hold the peak value of the signal output from the LPF 57.

At a constant frequency, the length (generation period) of the response signal (refer to FIGS. 12A to 12C) output from the receiving electrode 8 in response to the drive signal is determined based on the number of pulses of one receiving electrode 8, specifically, the number of pulses applied to one receiving electrode 8 during a selected period. Appropriately setting the number of pulses of one receiving electrode 8 allows the output signal from the LPF 57 to have the waveform indicated with the solid line in FIG. 13.

In the present embodiment, the antenna 18 is provided to detect the radiated noise of the PDP 2, as shown in FIG. 1. Alternatively, the receiving electrodes 8 may be configured to serve as an antenna to detect the radiated noise.

In the present embodiment, the antenna 18 detects the radiated noise of the PDP 2 and, based on the output signal from the antenna 18, the antenna receiving circuit 19 detects the sustained discharge period of the PDP 2. A sustained discharge detector in the present invention is not limited to the above. For example, radiated light of the PDP 2 may be detected by an optical sensor and the sustained discharge period of the PDP 2 may be detected based on output signals from the optical sensor. In this case, it is preferred that pixels be constantly turned on in an area monitored by the optical sensor in the display area of the PDP 2, such that sustained discharge occurs in all sub-fields. The optical sensor may detect either visible light or infrared light.

In the present embodiment, the sustained discharge period of the PDP 2 is detected based on the radiated noise of the PDP 2. Alternatively, a signal indicating the sustained discharge period may be output from the PDP 2 and, based on the signal, the sustained discharge period may be detected on the touch screen device 4. In this case, a signal generator should be provided in the PDP 2. In contrast, it is unnecessary to add a special component in the PDP 2 with the configuration in which the sustained discharge period is detected based on the radiated noise or radiated light of the PDP 2, thus simplifying implementation and preventing an increase in the manufacturing cost.

In the present embodiment, scanning is performed regardless of the sustained discharge period of the PDP 2, the detection data obtained during the sustained discharge period is discarded, and scanning is performed again to obtain data for the discarded detection data at an electrode intersection again, as shown in FIG. 7. In the present invention, however, a touch position only needs to be calculated based on detection data at each electrode intersection obtained during a period other than the sustained discharge period. For example, scanning may be performed avoiding the sustained discharge period and a touch position may be calculated based on the obtained detection data at each electrode intersection.

In the present embodiment, the transmitting electrodes 7 and the receiving electrodes 8 are composed of mesh electrodes, as shown in FIG. 2. The transmitting electrodes and the receiving electrodes in the present invention are not limited to this embodiment. For example, conductive wires that serve as electrodes may be arrayed in one direction only. Other than electrodes composed of opaque metal materials, transparent electrodes composed of Indium Tin Oxide (ITO), for example, may also be employed.

The touch screen device and the plasma display apparatus having the same according to the present invention can prevent a reduction in detection accuracy of a touch position affected by exogenous noise attributable to a plasma display panel, and are effective as a capacitance-type touch screen device detecting a touch position and a plasma display apparatus having the same.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch screen device comprising:
a screen main body comprising a plurality of transmitting electrodes provided parallel to one another and a plurality of receiving electrodes provided parallel to one another, the transmitting electrodes and the receiving electrodes being disposed in a grid shape;
a reference signal generator outputting a reference signal;
a transmitter generating a drive signal from the reference signal, sequentially selecting the transmitting electrodes and applying the drive signal;
a receiver sequentially selecting the receiving electrodes and receiving a response signal output from each of the receiving electrodes in response to the drive signal, the receiver comprising a synchronized detector performing synchronized detection for a signal based on the response signal from the receiving electrode, by using the reference signal, and generating detection data, at each electrode intersection, from a signal output from the synchronized detector; and
a controller obtaining a touch position based on the detection data at each electrode intersection output from the synchronized detector of the receiver.

2. The touch screen device according to claim 1, wherein the reference signal comprises a continuous pulse wave.

3. The touch screen device according to claim 2, wherein the drive signal comprises an intermittent pulse wave

4. The touch screen device according to claim 3, wherein the drive signal has a no-signal section at a time of switching the receiving electrodes.

5. The touch screen device according to claim 1, wherein
the receiver comprises a sine wave converter converting the reference signal output from the reference signal generator into a sine wave, and
the synchronized detector performs synchronized detection by using the reference signal converted into the sine wave by the sine wave converter.

6. The touch screen device according to claim 5, wherein the sine wave converter comprises a bandpass filter.

7. The touch screen device according to claim 5, wherein the synchronized detector comprises a multiplier that multiplies the signal based on the response signal from the receiving electrode and the reference signal converted into the sine wave by the sine wave converter.

8. The touch screen device according to claim 7, wherein the synchronized detector comprises a low pass filter that removes a component from an output signal of the multiplier.

9. The touch screen device according to claim 3, wherein a length of the response signal output from the receiving electrode is set such that the signal output from the synchronized detector declines after reaching a peak value.

10. The touch screen device according to claim 9, wherein the receiver comprises a peak value obtainer obtaining a substantially maximum value of the signal output from the synchronized detector and generates the detection data from a signal output from the peak value obtainer.

11. The touch screen device according to claim 1, wherein the screen main body is disposed in front of the plasma display panel.

12. The touch screen device according to claim 11, further comprising:
an antenna detecting a radiated noise from the plasma display panel; and
a sustained discharge detector detecting a sustained discharge period of the plasma display panel based on an output signal from the antenna.

13. The touch screen device according to claim 12, wherein the controller obtains a touch position based on detection data at each electrode intersection obtained during a period other than the sustained discharge period from a detection result of the sustained discharge detector.

14. The touch screen device according to claim 13, wherein the controller discards detection data obtained during the sustained discharge period.

15. The touch screen device according to claim 3, the receiver comprising a sampler/holder that samples a signal output from a low pass filter proximate a peak value of the output signal.

16. The touch screen device according to claim 12, wherein the receiving electrodes comprise the antenna.

17. The touch screen device according to claim 12, wherein the antenna comprises a looped conductive wire mounted on a board.

18. The touch screen device according to claim 12, the antenna having a resonant frequency proximate an operating frequency of a plasma display panel associated with the touch screen device.

19. The touch screen device according to claim 14, wherein the controller again performs scanning after discarding the detection data obtained during the sustained discharge period.

20. A plasma display apparatus comprising the touch screen device according to claim 1 provided in front of a plasma display panel.
